(19) United States
(12) Patent Application Publication
(10) Pub. No.: US 2026/0043298 A1
(43) Pub. Date: Feb. 12, 2026

(54) SMART RAIL FOR WINDOW COVERING

(71) Applicant: Klondike59, Inc., Park City, UT (US)

(72) Inventors: Andrew E. EINAUDI, Scotts Valley, CA (US); Benjamin M. RAPPOPORT, Bainbridge Island, WA (US)

(21) Appl. No.: 19/150,067

(22) PCT Filed: Jan. 24, 2024
(86) PCT No.: PCT/US2024/012806

§ 371 Date: Jul. 22, 2025

Related U.S. Application Data
(60) Provisional application No. 63/481,317, filed on Jan. 24, 2023.
(60) Provisional application No. 63/488,622, filed on Mar. 6, 2023.

(51) Int. Cl. E06B 9/72; E06B 9/24; E06B 9/42; E06B 9/68; H02J 7/00; H02J 7/34; H02J 7/35; H02S 20/22; H02S 30/20

(52) U.S. Cl. CPC E06B 9/72; E06B 9/42; H02J 7/0048; H02J 7/00712; H02J 7/342; H02J 7/35; H02S 20/22; H02S 30/20; E06B 2009/2476; E06B 2009/6818

(57) ABSTRACT

Systems and methods are described herein for a smart rail with integrated sensors, microcontroller, solar panel and battery to create a dynamic shading system that is self-sufficient, and fault tolerant. In most motorized window coverings, the rechargeable motor resides in the top rail bar so that the smart rail requires a docking mechanism to charge the rechargeable motor—for the sake of this patent, this will be referred to as a “distributed smart rail motor system”. In other window coverings, such as certain cellular shades and horizontal blinds, it is feasible to further integrate the rechargeable motor into the smart rail for a completely integrated solution—for tan “sake of this patent, this will be referred to as an “integrated smart rail motor system”. A system and method are also disclosed herein for cutting fabric in-place on an adjustable shade roller.

### CROSS-REFERENCE TO RELATED APPLICATIONS

This application claims priority to U.S. Provisional Application No. 63/481,317, filed Jan. 24, 2023, and U.S. Provisional Application No. 63/488,622, filed Mar. 6, 2023, which are incorporated by reference herein in their entireties.

### BACKGROUND

Window shades are an effective way to provide privacy, block out light and heat or insulate from heat loss. Despite there being some standard sizes for windows, the windows boxes, window moldings and window openings that windows sit inside have a lot of variation in size and dimension. Therefore, the fabric to cover a window often requires a custom width to perform the job of adequately blocking the light or looking proper aesthetically—especially for blackout shades. Custom shade rods and fabric widths are either trimmed in factory, in-store at large cutting machines or at home with hacksaws and scissors which is prone to errors and/or injury.

Buildings consume 36% of global energy and nearly three-quarters of that energy is spent on heating and cooling. Typically, the number one source of energy loss in buildings is windows. Window coverings such as roller shades, cellular shades, zebra blinds, horizontal blinds and others can be an effective way to reduce energy waste. However, according to a Lawrence Berkeley Lab study, the most common type of window coverings, those which are manually operated, have on average no effect on heating & cooling consumption versus windows without coverings. This is where dynamic automated shading can make a real difference, as it can adjust to changing conditions and optimize energy use, reducing energy waste by more than 20%.

Typical dynamic shading systems rely on sensors such as light, heat, humidity, user occupancy and others to make decisions about when to raise or lower a window treatment for maximum benefit. Most often, these sensors are maintained separately and/or battery powered such that installation, maintenance, communication, and power failures can hinder optimum operation of the dynamic shading system.

### SUMMARY

Systems and methods are described herein for a smart rail with integrated sensors, microcontroller, solar panel and battery to create a dynamic shading system that is self-sufficient, and fault tolerant. In most motorized window coverings, the rechargeable motor resides in the top rail bar so that the smart rail requires a docking mechanism to charge the rechargeable motor—for the sake of this patent, this will be referred to as a “distributed smart rail motor system”. In other window coverings, such as certain cellular shades and horizontal blinds, it is feasible to further integrate the rechargeable motor into the smart rail for a completely integrated solution—for tan “sake of this patent, this will be referred to as an “integrated smart rail motor system”.

A system and method is also disclosed herein for cutting fabric in-place on an adjustable shade roller.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein

### BRIEF DESCRIPTION OF THE DRAWINGS/FIGURES

The accompanying drawings, which are incorporated herein and form part of the specification, illustrate embodiments of the application and, together with the description, further serve to explain the principles of the embodiment and to enable a person skilled in the relevant art(s) to make and use the embodiments.

FIG. 1a depicts an interior window frame in detail indicating common naming conventions for window frame components.

FIG. 1b depicts an interior window covering in detail indicating common naming conventions for window covering components.

FIG. 1c depicts the outside facing view of the smart rail in detail indicating its key components and features. For an “integrated smart rail motor system”, a motor would also be present.

FIG. 1d depicts the inside facing view of the smart rail in detail indicating its key components and features. For an “integrated smart rail motor system”, a motor would also be present.

FIG. 2a depicts an inside mounted window covering in a completely open state. In the case of a “distributed smart rail system”, this is also considered to be the docking position when the smart rail can charge to the window covering's rechargeable motor battery due to its proximity to the bracket 110 and dongle interface 202.

FIG. 2b depicts an inside mounted window covering in a partially open/closed state. In the case of a “distributed smart rail system”, this is also considered to be the non-docking position when the smart rail is unable to charge to the window covering's rechargeable motor battery due to its loss of proximity to the bracket 110 and dongle interface 202.

FIG. 2c depicts an inside mounted window covering in a completely closed state. In the case of a “distributed smart rail system”, this is also considered to be the non-docking position when the smart rail is unable to charge to the window covering's rechargeable motor battery due to its loss of proximity to the bracket 110 and dongle interface 202.

FIG. 2d depicts an outside mounted window covering in a completely open state. In the case of a “distributed smart rail system”, this is also considered to be the docking position when the smart rail can charge to the window covering's rechargeable motor battery due to its proximity to the bracket 110 and dongle interface 202.

FIG. 2e depicts an outside mounted window covering in a partially open/closed state. In the case of a “distributed smart rail system”, this is also considered to be the non-docking position when the smart rail is unable to charge to the window covering's rechargeable motor battery due to its loss of proximity to the bracket 110 and dongle interface 202.

FIG. 2f depicts an outside mounted window covering in a completely closed state. In the case of a “distributed smart rail system”, this is also considered to be the non-docking position when the smart rail is unable to charge to the window covering's rechargeable motor battery due to its loss of proximity to the bracket 110 and dongle interface 202.

FIG. 2g depicts the inside view of a “distributed smart rail system” docked and charging motor 203 showing key component details of the smart rail 201 and window covering bracket 110, dongle interface 202, charging cable 204, rechargeable motor 203 and smart rail 201.

FIG. 2h depicts the side view of a “distributed smart rail system” docked and charging motor 203 showing key component details of the smart rail 201 and window covering bracket 110, dongle interface 202, charging cable 204, rechargeable motor 203 and smart rail 201.

FIG. 2i depicts the outside view of a “distributed smart rail system” docked and charging motor 203 showing key component details of the smart rail 201 and window covering bracket 110, dongle interface 202, charging cable 204, rechargeable motor 203 and smart rail 201.

FIG. 2j depicts the inside view of a “distributed smart rail system” partially open/closed in an undocked position showing key component details of the smart rail 201 and window covering bracket 110, dongle interface 202, charging cable 204, rechargeable motor 203 and smart rail 201.

FIG. 2k depicts the side view of a “distributed smart rail system” partially open/closed in an undocked position showing key component details of the smart rail 201 and window covering bracket 110, dongle interface 202, charging cable 204, rechargeable motor 203 and smart rail 201.

FIG. 2l depicts the outside view of a “distributed smart rail system” partially open/closed in an undocked position showing key component details of the smart rail and window covering bracket, dongle interface, charging cable, rechargeable motor and smart rail.

FIG. 2m depicts the dongle and smart rail end cap charging contacts for “distributed smart rail system” indicating options for both reverse roll and standard roll operation for certain window covering systems including roller shades, zebra blinds and others.

FIG. 2n depicts the inside view of a “integrated smart rail system” where the sensors, microcontroller, solar panel, rechargeable battery and motor are all integrated into the rail.

FIG. 2o depicts the outside view of a “integrated smart rail system” where the sensors, microcontroller, solar panel, rechargeable battery and motor are all integrated into the rail.

FIG. 3a depicts smart rail microcontroller logic with label inputs/outputs for decision making and control operation of microcontroller 300. This diagram pertains to both “distributed smart rail system”and “integrated smart rail system”systems.

FIG. 3b depicts a “distributed smart rail system” motor charging logic diagram.

FIG. 4a depicts an interior window frame.

FIG. 4b depicts an interior window frame in detail with perspective and labels of pertinent facia for mounting a window system.

FIG. 5a-1 depicts bracket mounting locations for an “Outside Mount” window system.

FIG. 5a-2 depicts bracket mounting locations for an “Inside Mount” window system.

FIG. 5b-1 depicts the installation of an adjustable shade rod being installed in an “Outside Mount”window system.

FIG. 5b-2 depicts the installation of an adjustable shade rod being installed in an “Inside Mount”window system.

FIG. 5c depicts the cutter being installed on the adjustable shade rod with fabric.

FIG. 5d depicts the cutter having begun cutting fabric on the roller in place.

FIG. 5e depicts the cutter having almost completed cutting all fabric on the roller in place.

FIG. 5f depicts the cut being complete.

FIG. 5g depicts after the cut is complete, the belt is removed.

FIG. 5h depicts after the cut is complete, the cutter is removed.

FIG. 6 depicts the cut shade being rolled down after completion of cutting.

FIG. 7 depicts detailed views of the cut-side bracket.

FIG. 8a depicts detailed views of the cutter.

FIG. 8b depicts detailed views of the cutter, cut-side bracket, rod and fabric attach/hem systems.

FIG. 8c depicts detailed views of the cutter, cut-side bracket, and fabric systems.

FIG. 8d depicts the cutter and cut-side brackets together.

FIG. 9 depicts an attach rod interface feature and an attach rod negative feature.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments but also encompasses combinations of the disclosed embodiments, as well as modifications to the disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures and drawings described herein can be spatially arranged in any orientation or manner. Additionally, the drawings may not be provided to scale, and orientations or organization of elements of the drawings may vary in embodiments.

As used herein, the term “interior window frame” refers to the side of a window frame interior to a dwelling (e.g., a room, a home, an office, a retail space, etc.) for a window frame affixed in a wall of the dwelling. The term “inside mount window covering” refers to a window covering mounted within a window frame. The term “outside mount window covering” refers to a window covering mounted to or outside the window frame, such as being mounted to the wall above the window frame or the head casing of the window frame. The term “outside facing view,” when used with respect a smart rail, refers to a side of the smart view that faces toward the exterior of a dwelling (e.g., through the window) when affixed to a window covering as described herein. The term “inside facing view,” when used with respect a smart rail, refers to a side of the smart view that faces toward the interior of a dwelling when affixed to a window covering as described herein. The term “completely closed” with reference to a window covering refers to the window covering being fully retracted. In a completely closed position, light may pass through substantially the entire window (e.g., the glass panes) associated with the window covering without being impeded by the window covering. The term “completely closed” with reference to a window covering refers to the window covering being fully extended. In a completely closed position, light is impeded from passing through substantially all of the associated window.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Smart Rail for Window Covering

As noted in the Background Section above, window coverings are an effective way to block out light and heat or insulate from heat loss and save energy. Dynamic shade systems maximize savings by using sensor data to make intelligent decisions. However, most commonly these sensor systems, microcontrollers and power systems have been separated which leads to high cost, installation, maintenance and troubleshooting problems.

Embodiments disclosed herein for the smart rail for window coverings that integrate the sensors, microcontroller, power source via solar panel and battery into a system that can raise and lower with the window covering apparatus. For distributed smart rail architectures, the smart rail for window covering offers the unique side benefit of charging the shade motor used to raise and lower the window covering. These and further benefits of the disclosed embodiments are described as follows.

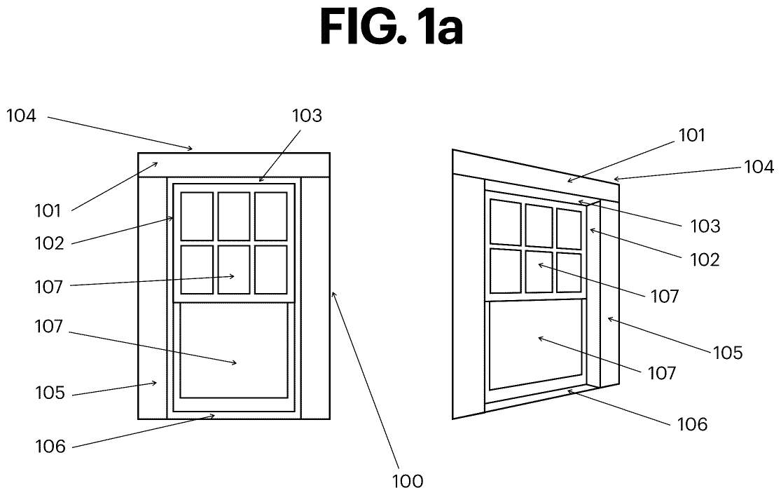

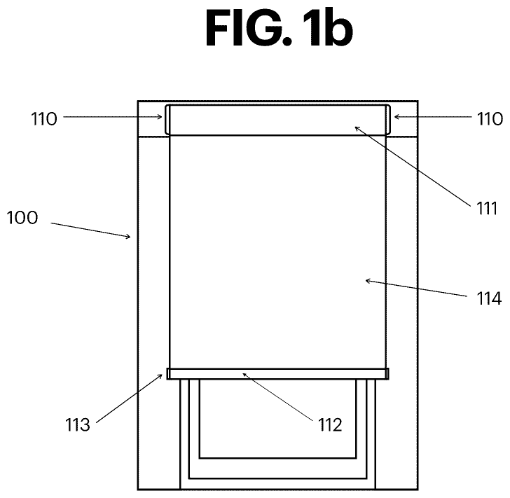

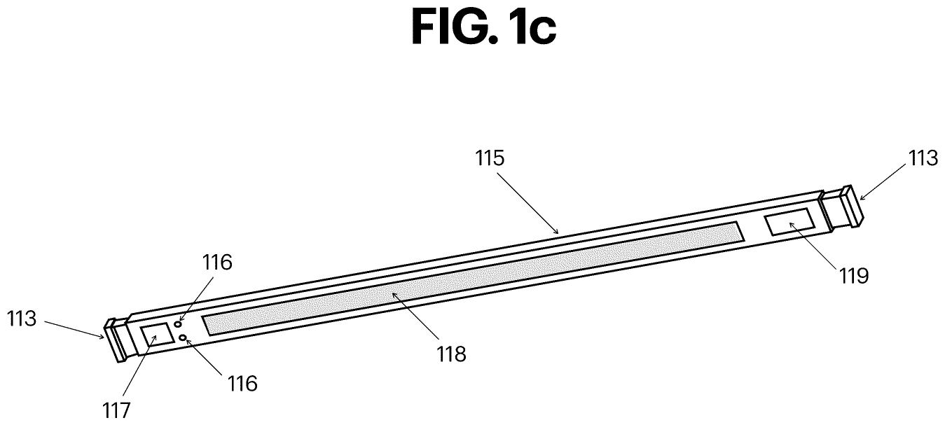

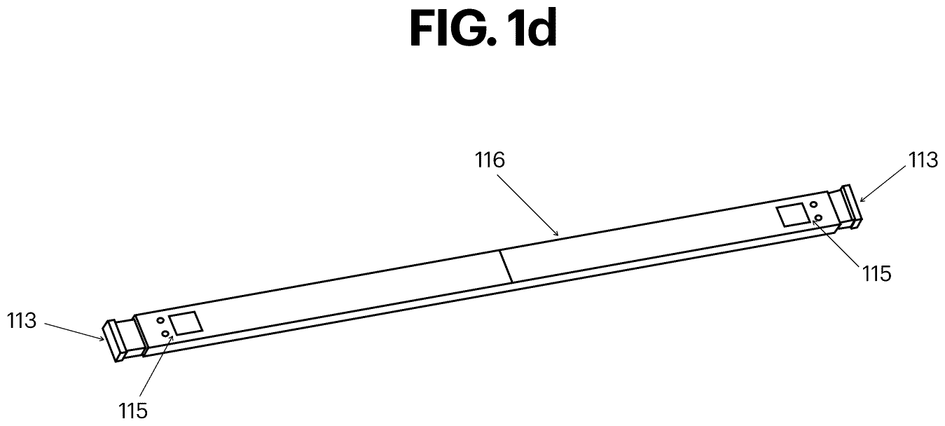

In particular, FIG. 1a depicts an interior window frame in detail comprising a head casing 101, a side jamb extension 102, head jamb extension 103, side casing 105, windowsill (“sill”) 106 and glass panes 107 combining to create the window 100 structure and surrounded by wall 104 area. Head casing 101, side jamb extension 102, head jamb extension 103, wall 104, and in some cases side casing 105, all provide suitable mounting locations for window coverings. The sill 106 is often the logical limit for inside mount window coverings which will be discussed later.

FIG. 1b depicts an interior window covering, overlaying window 100, in detail indicating brackets 110, head rail 111, bottom rail 112, rail endcaps 113 and fabric/blades 114. For roller shades, cellular shades, zebra blinds, the material for the window covering is typically referred to as fabric 114, while horizontal blinds use the term blades 114.

FIG. 1c depicts the smart rail in detail from an outside facing view. Consequently, the outside facing view indicates the outside facing sensors 116 which may primarily include heat, light and humidity but may also include proximity, air quality, smoke, gas, level, pressure, accelerometer, compass, glass break, IR (infrared), and other sensors. Additionally, the solar panel 118 is facing outside for optimal sun charging. The microcontroller 119 and integrated battery 117 are also shown. The microcontroller 119 may also include wireless interfaces such as IR, RF (radio frequency), Wi-Fi, Bluetooth as well as wired interfaces to communicate to motors, sensors, and batteries. These wireless interfaces may communicate with the cloud (i.e., network-based servers and services, such as available on the Internet) to get weather based on location or zip code, software updates or local network to integrate with other sensors and/or controls.

FIG. 1d depicts the smart rail in detail from an inside facing view. Consequently, the inside facing view indicates the inside facing sensors 115 which may primarily include occupancy, heat, light and humidity but may also include proximity, air quality, smoke, gas, level, pressure, accelerometer, compass, glass break, IR and other sensors. Occupancy is particularly useful in residential application where a user's presence in the room may override specific dynamic shading logic. For example, window coverings are often used for privacy. If a window covering is in the down position providing a user privacy in the room, they may not want the dynamic shading system to open the window covering for energy savings while they are in the room. Additionally, despite the solar panel 118 facing outside for optimal sun charging, there may be a use for inside facing solar panel for cases where ambient light can charge the solar panel adequately. The microcontroller 119 and integrated battery 117 are not shown but are considered to be present under the smart rail chassis. The microcontroller 119 may also include wireless interfaces such as IR, RF, Wi-Fi, Bluetooth as well as wired interfaces to communicate to motors, sensors and batteries. These wireless interfaces may communicate with the cloud to get weather based on location or zip code, software updates or local network to integrate with other sensors and/or controls.

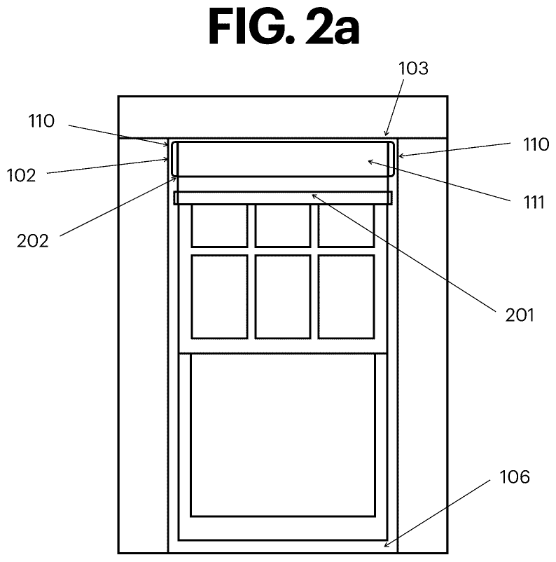

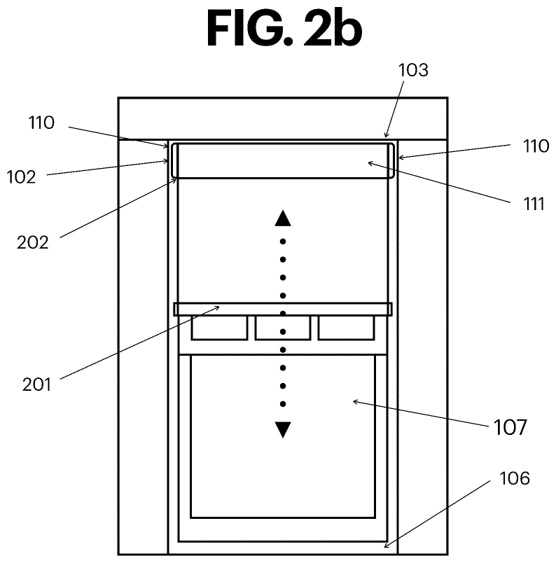

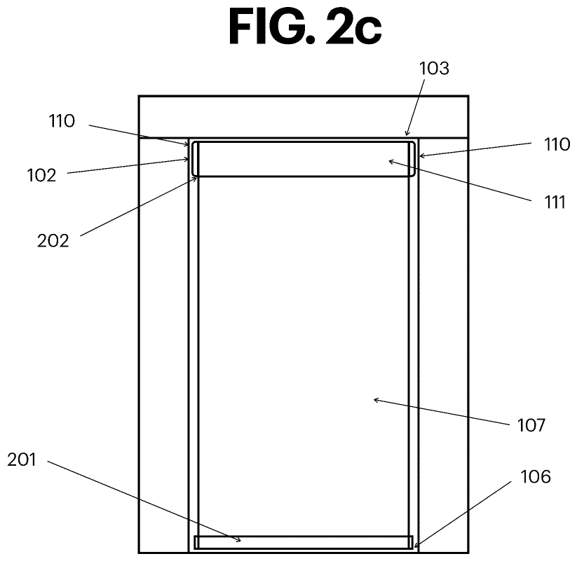

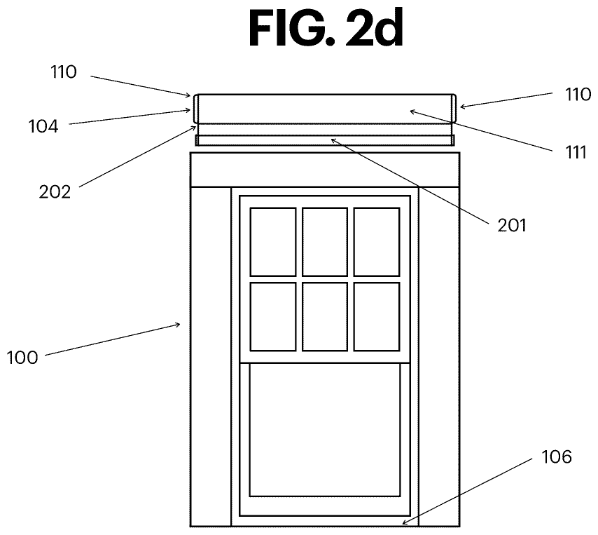

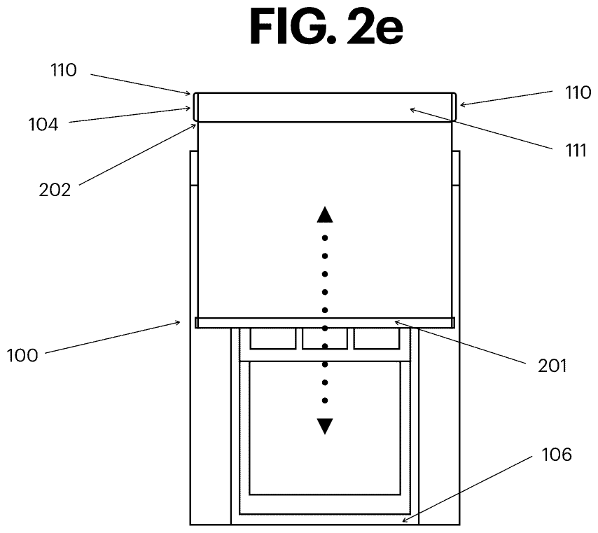

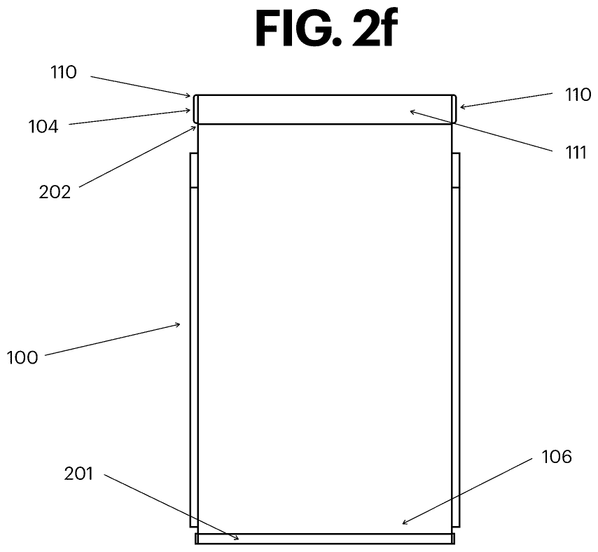

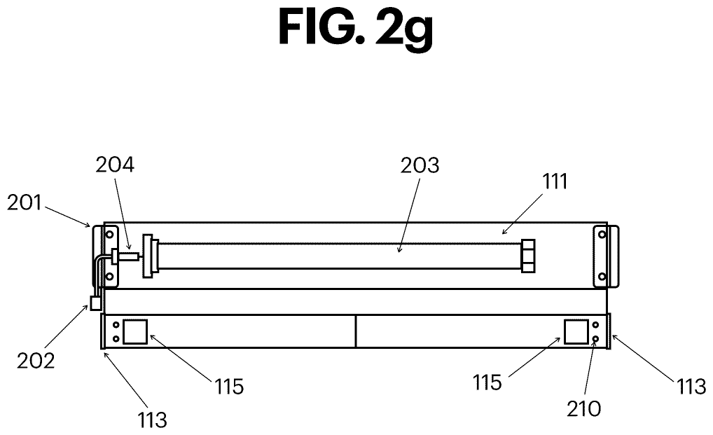

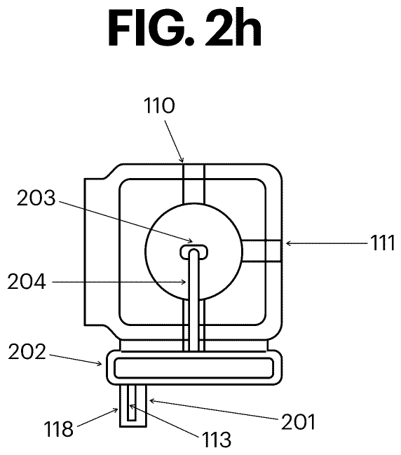

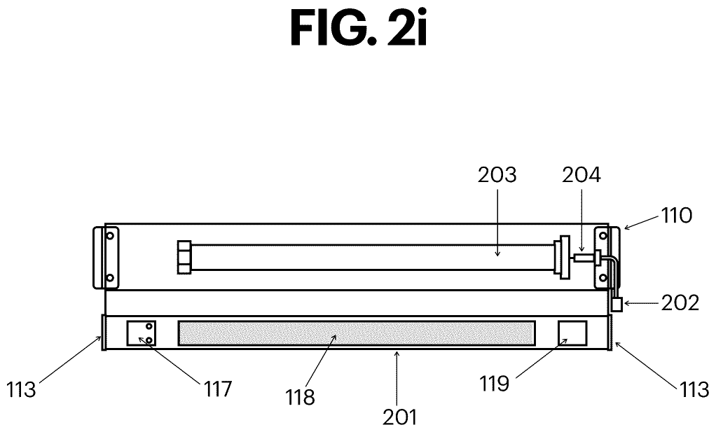

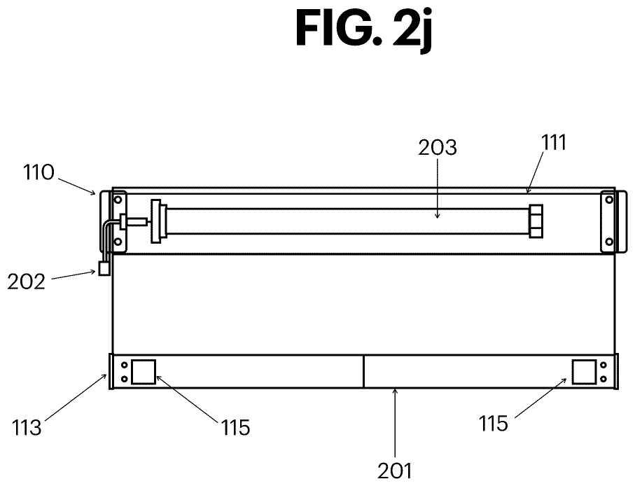

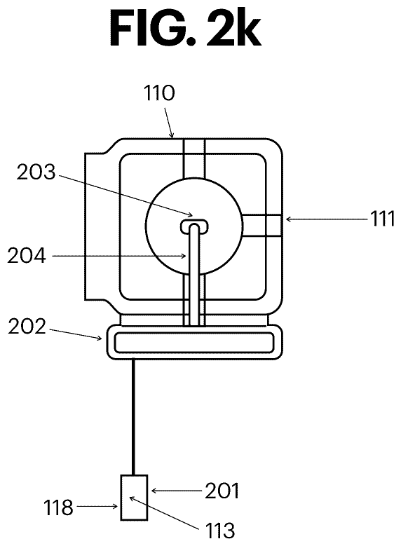

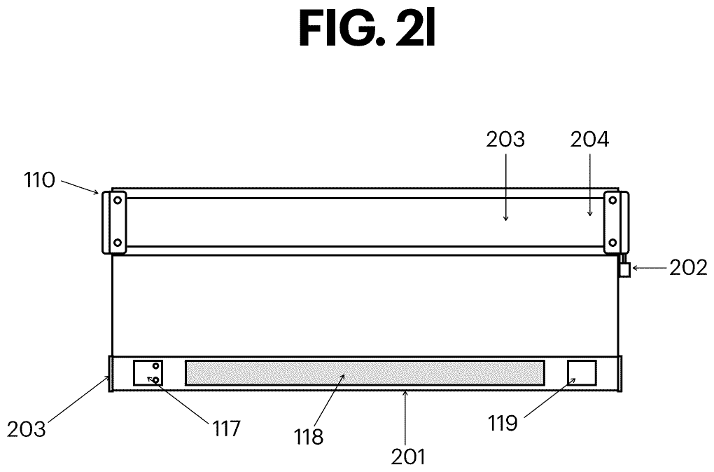

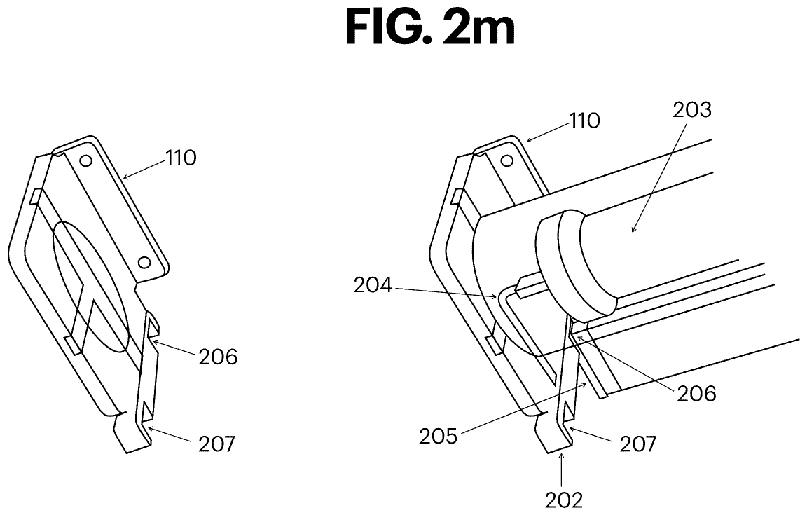

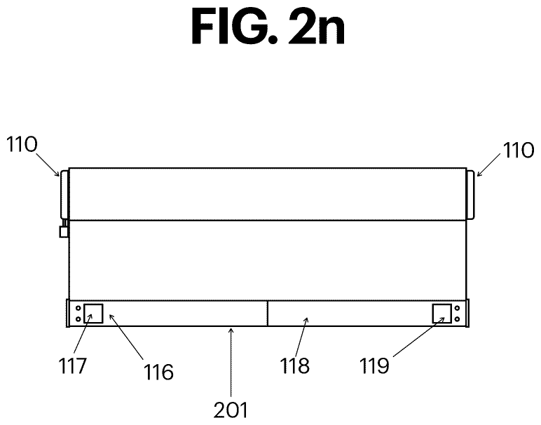

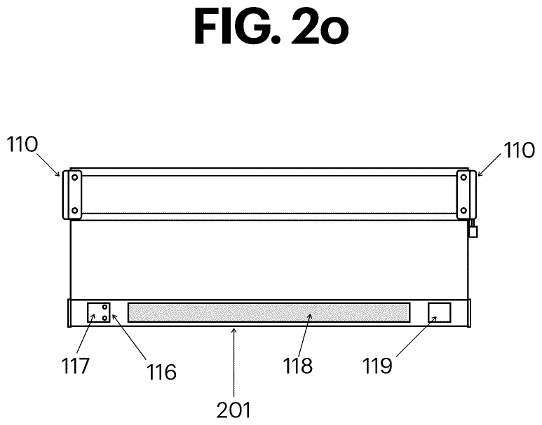

FIG. 2a illustrates an inside mount window covering completely open with mounting bracket 110 connected to either the side jamb extension 102 or head jamb extension 103. In the case of a “distributed smart rail system”, this is also considered to be the docking position when the smart rail 201 can charge the window covering's rechargeable motor due to its of connection/proximity to the bracket 110 and dongle interface 202. In this open position, the smart rail 201 outside facing sensors and/or solar panel may be partially or completely unable to collect data and/or solar charge but inside facing sensors will work.

FIG. 2b illustrates an inside mount window partially open/closed with mounting bracket 110 connected to either the side jamb extension 102 or head jamb extension 103. In the case of a “distributed smart rail system”, this is also considered to be the non-docking position when the smart rail is unable to charge to the window covering's rechargeable motor due to its loss of proximity to the bracket 110 and dongle interface 202. In this partially opened/closed position, the smart rail 201 outside facing sensors and/or solar panel should be able to optimize position to collect data and/or solar charge and inside facing sensors will work continue to work well.

FIG. 2c illustrates an inside mount window completely closed with mounting bracket 110 connected to either the side jamb extension 102 or head jamb extension 103. In the case of a “distributed smart rail system”, this is also considered to be the non-docking position when the smart rail is unable to charge to the window covering's rechargeable motor due to its loss of proximity to the bracket 110 and dongle interface 202. In this closed position, the smart rail 201 outside facing sensors and/or solar panel may be partially or completely unable to collect data and/or solar charge but inside facing sensors will work, depending on the height of the sill 106 relative to the opening of the glass panes 107. It is worth noting that inside mount window coverings often achieve the best insulative properties compared to other mounting methods. In the case of a very tight fit and good seal, comparing the inside and outside sensor readings may provide a powerful tool to determine the exact insulative value of the window covering.

FIG. 2d illustrates an outside mount window covering completely open with mounting bracket 110 connected to either the head casing 101 or wall 104. In the case of a “distributed smart rail system”, this is also considered to be the docking position when the smart rail 201 can charge the window covering's rechargeable motor due to its of connection/proximity to the bracket 110 and dongle interface 202. In this open position, the smart rail 201 outside facing sensors and/or solar panel may be partially or completely unable to collect data and/or solar charge due to head casing 101 or wall 104 blockage but inside facing sensors will work.

FIG. 2e illustrates an outside mount window partially open/closed with mounting bracket 110 connected to either the head casing 101 or wall 104. In the case of a “distributed smart rail system”, this is also considered to be the non-docking position when the smart rail is unable to charge to the window covering's rechargeable motor due to its loss of proximity to the bracket 110 and dongle interface 202. In this partially opened/closed position, the smart rail 201 outside facing sensors and/or solar panel should be able to optimize position to collect data and/or solar charge and inside facing sensors will continue to work well.

FIG. 2f illustrates an outside mount window completely closed with mounting bracket 110 connected to either the head casing 101 or wall 104. In the case of a “distributed smart rail system”, this is also considered to be the non-docking position when the smart rail is unable to charge to the window covering's rechargeable motor due to its loss of proximity to the bracket 110 and dongle interface 202. In this closed position, the smart rail 201 outside facing sensors and/or solar panel may be partially or completely unable to collect data and/or solar charge due to head casing 101 or wall 104 blockage but inside facing sensors will work, depending on the height of the sill 106 relative to the opening of the glass panes 107.

FIG. 2g illustrates an inside view of the distributed smart rail system docked and charging rechargeable motor 203 in detail. The smart rail 201 is docked into the dongle interface 202 which has a physical connection via the charging cable 204 to connect the rechargeable motor 203 battery to the solar battery 117. Because this is an inside view, the solar panel may or may not be visible.

FIG. 2h illustrates a side view of the distributed smart rail system docked and charging rechargeable motor 203 in detail. The smart rail 201 is docked into the dongle interface 202 which has a physical connection via the charging cable 204 to connect the rechargeable motor 203 battery to the solar battery 117. The solar panel 118 is shown facing the outside view.

FIG. 2i illustrates an outside view of the distributed smart rail system docked and charging rechargeable motor 203 in detail. The smart rail 201 is docked into the dongle interface 202 which has a physical connection via the charging cable 204 to connect the rechargeable motor 203 battery to the solar battery 117. Because this is an outside view, the solar panel 118 is visible but may be hidden behind fabric if the openness factor of the fabric allows enough solar energy to get to the solar panel 118.

FIG. 2j illustrates an inside view of the distributed smart rail system partially open/closed. This is also considered to be the non-docking position when the smart rail is unable to charge to the window covering's rechargeable motor due to its loss of proximity to the bracket 110 and dongle interface 202. The smart rail 201 should be in an ideal position to use its solar panel 118 to charge its solar battery 117. Additionally, both the inside facing sensors 115 and outside facing sensors 116 should be able to take optimal readings. Because this is an inside view, the solar panel may or may not be visible.

FIG. 2k illustrates a side view of the distributed smart rail system partially open/closed. This is also considered to be the non-docking position when the smart rail is unable to charge to the window covering's rechargeable motor due to its loss of proximity to the bracket 110 and dongle interface 202. The smart rail 201 should be in an ideal position to use its solar panel 118 to charge its solar battery 117. Additionally, both the inside facing sensors 115 and outside facing sensors 116 should be able to take optimal readings. Because this is an inside view, the solar panel may or may not be visible.

FIG. 2l illustrates an outside view of the distributed smart rail system partially open/closed. This is also considered to be the non-docking position when the smart rail is unable to charge to the window covering's rechargeable motor battery due to its loss of proximity to the bracket 110 and dongle interface 202. The smart rail 201 should be in an ideal position to use its solar panel 118 to charge its solar battery 117. Additionally, both the inside facing sensors 115 and outside facing sensors 116 should be able to take optimal readings.

FIG. 2m illustrates a distributed smart rail system and dongle in detail. The bracket 110 connects the dongle interface 202 to the rechargeable motor 203 via a charging cable 204. When the smart rail 201 is in the completely open position, the rail charging contacts 205 on the rail endcaps 113 connect electrically and/or physically with the dongle charging contacts standard roll 206 or dongle charging contacts reverse roll 207. These electrical connections can be achieved by physical contact or using inductive or other proximity based charging technologies. For roller shades and zebra shades, there are two types of roll configurations called standard roll and reverse roll. With a standard roll, the fabric will lay flat against the window and raise up onto the roller bar from behind when the shade is raised. With a reverse roll, the shade fabric will wrap over the top of the roller bar and hang in front of the window like a waterfall. To provide charging contacts for both of these scenarios, the dongle interface 202 has both dongle charging contacts standard roll 206 or dongle charging contacts reverse roll 207.

FIG. 2n illustrates an integrated smart rail system with rechargeable motor from the inside view. This integrated solution is best suited for cellular and horizontal blinds, but can also be adapted for roller shades where the rechargeable motor lives in the rail system. A nice thing about this system is that there is no need to support a docking feature and the rechargeable battery is shared. The entire integrated smart rail features integrated inside and outside mounted sensors, microcontroller as well as solar panel and rechargeable motor in one package.

FIG. 2o illustrates an integrated smart rail system with rechargeable motor from the outside view. This integrated solution is best suited for cellular and horizontal blinds, but can also be adapted for roller shades where the rechargeable motor lives in the rail system. A nice thing about this system is that there is no need to support a docking feature and the rechargeable battery is shared. The entire integrated smart rail features integrated inside and outside mounted sensors, microcontroller as well as solar panel and rechargeable motor in one package.

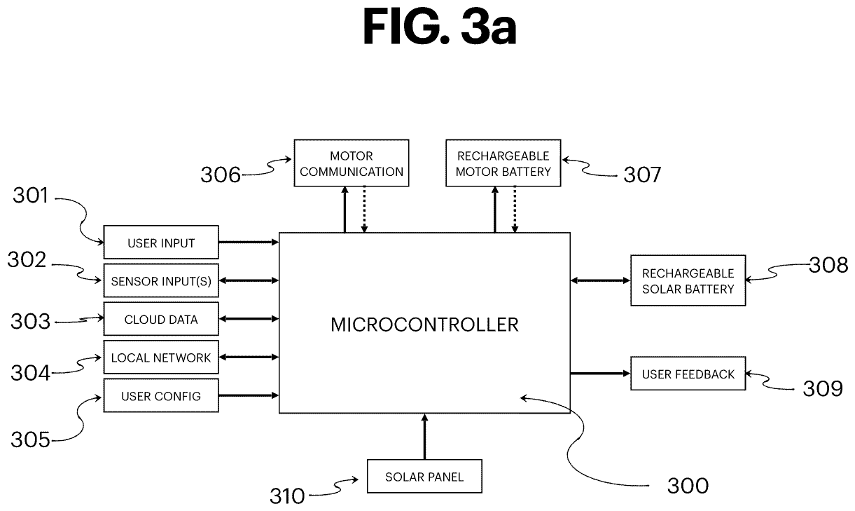

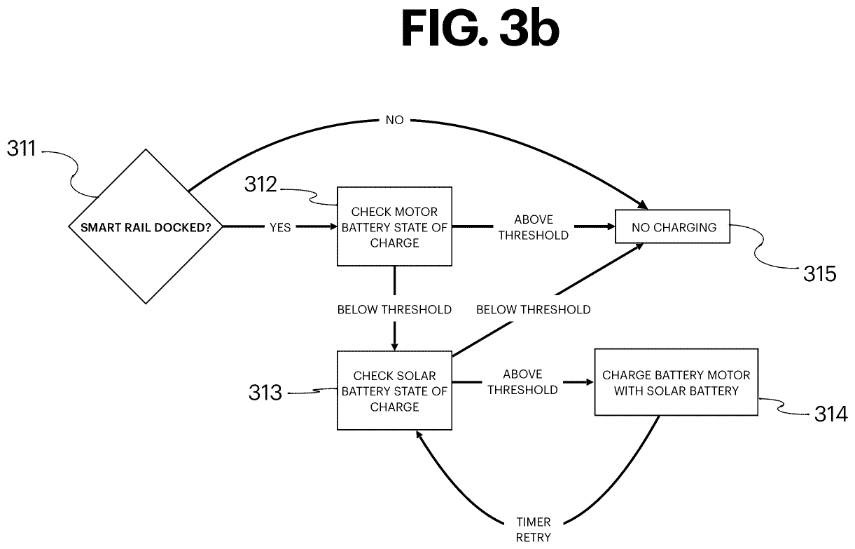

FIG. 3a illustrates the smart rail microcontroller logic diagram. The microcontroller 300 interconnects user input 301 such as buttons, switches and capacitive touch controllers to allow the user to control (raise, lower, stop) or set preferences (disable/enable dynamic shading) and other options. Additionally, the user can modify their user config 305 using a network connected device to set energy savings preferences on the dynamic shade. User input 301 may also come from wireless interfaces such as IR, RF, Wi-Fi, Bluetooth which may be initiated by remote control or smart phone or other wireless device or controller. Cloud data 303 and local network 304 devices such as controllers or sensors or smart home devices can also issue controls and/or update dynamic shade settings. Cloud data 303 shall also include weather data or cloud-based firmware updates to the microcontroller 300. Local network 304 devices can also update the firmware of the microcontroller 300. Sensor inputs 302 from integrated sensors such as occupancy, heat, light, proximity, air quality, smoke, gas, level, pressure, accelerometer, compass, glass break, IR and other sensors can further assist the microcontroller 300 to make decisions on raising and lowering the window covering. For instance, the occupancy sensor may be helpful to determine when to and when not to automatically raise a shade. If a user is in the room, they may feel raising the shade automatically is an invasion of their privacy or annoying. There are multiple types of occupancy sensors that may be employed such as convention passive infrared (PIR) or more modern millimeter wave (mmWave). Also, the ability for the shade to dynamically move its sensors may allow for more dynamic algorithms, such as ability to find the actual peak incidence of sun for solar charging or advance occupancy detection or security feature. An accelerometer sensor can also be considered as user input 301 in cases where the user tugs on the rail to indicate they want the window covering to raise or lower or stop. An accelerometer sensor can also be used to determine the stop of the shade when it hits the windowsill. Other opportunities for energy efficiency optimization and measurement include the ability to measure differential sensor readings such as light, heat and humidity sensors on inside and outside facing sides of the rail to determine things like quality of seal of the window covering or detecting error cases. A common problem with high performing window coverings on single pane windows is water condensation. The integrated humidity sensor can alert a user to a water condensation issue and raise the window covering automatically to remedy or call the issue to a user's attention. A level sensor can indicate when the window covering is not mounted properly or has settled over time. Glass break sensors are suitable for security applications as windows are common entry points for thieves. Gas, smoke and air quality are also helpful indicators of other emergencies a household or business may be facing. IR may be used to support external IR remote control features without the need for wireless pairing. The microcontroller 300 also uses motor communication 306 to understand the state of the motor or set motor settings such as torque, speed or set limits. Motor charge 307 can be used to optimally manage the charge state of the rechargeable motor for maximum lifetime. The solar battery 308 charging and discharging logic is managed by the microcontroller 300. In certain cases, the dynamic shading system will need to communicate feedback to the end user. For this purpose, user feedback 309 is used to provide lighting, sound or voice feedback to let the user know of pending window covering state change(raise/lower) or error or state of charge or something else. The solar battery 308 is connected to the microcontroller 300 and logic inside the microcontroller determines when the solar panel 310 should charge the solar battery 308.

FIG. 3b illustrates the distributed smart rail motor charging logic. To maintain optimum battery life, the charging logic will determine proper thresholds for when the solar battery should charge the motor battery. When the smart rail is docked 311, the logic should check the motor battery's state of charge 312. If the motor battery's state of charge 312 is below a threshold and the solar battery state of charge 313 is above a threshold, then the charge motor battery with solar battery 314 operation should commence. The state machine should check the solar battery state of charge 313 on a time interval to make sure that the solar battery state of charge 313 does not go below threshold. If the solar battery state of charge 313 goes below threshold, then the no charging 315 action should be taken. Also, if the check motor battery state of charge 312 is above threshold, no charging 315 action should be taken.

Note that although embodiments are described herein with the smart rail (e.g., rail 201) including a solar battery (e.g., solar battery 117) that receives charge from a solar panel (e.g., solar panel 118), in other embodiments, the smart rail may include one or more batteries of other battery type(s). As used herein, the term “rail battery” encompasses any type and number of batteries included in the smart rail, such as solar battery 117, a battery that receives charge from another source (e.g., a wall socket), a non-rechargeable battery, and/or another battery of suitable type.

Accordingly, embodiments include:
A smart rail for window covering system in accordance with any of the embodiments described herein, and/or located in any placement on a window covering system included top rail, bottom rail, middle rail or any location attached or not attached to fabric/blades.
A smart rail for window covering system for a window shade, a screen door, a window screen, a window awning, or a video projection screen in accordance with any of the embodiments described herein.
A distributed smart rail system that integrates a variety of sensors such as occupancy, heat, light, proximity, air quality, smoke, gas, level, pressure, accelerometer, compass, glass break, IR and other sensors combined with or without solar power and docking capability to recharge the window covering or shade motor that operates a window covering.
An integrated smart rail-system that integrates a variety of sensors such as occupancy, heat, light, proximity, air quality, smoke, gas, level, pressure, accelerometer, compass, glass break, IR and other sensors combined with or without solar power and rechargeable motor that operates the window covering.
A microcontroller combined with cloud, local network, and user input control that can determine a dynamic schedule for controlling window coverings based on zip code, time of day and window covering orientation as well as embedded sensor information, user configs and user inputs.
A smart rail for a window covering that can raise and lower a variety of sensors for multiple readings and or sensing such as occupancy, heat and/or light readings.
A smart rail for a window covering that can dynamically move a solar panel to find a peak incidence of sun for solar charging or optimal charging positioning.
A smart rail for a window covering that uses an accelerometer sensor for user input to indicate they want the window covering to raise or lower or stop.
A smart rail for a window covering that uses an accelerometer, proximity, or other sensor to determine a of a shade when it hits a windowsill.
A smart rail for a window covering that uses a variety of energy efficiency optimization and measurement include an ability to measure differential sensor readings such as light, heat, humidity and other sensors on inside and outside facing sides of the rail to determine things like quality of seal of the window covering or detecting error cases.
A smart rail for a window covering that uses a humidity sensor to alert a user to a water condensation issue and raise the window covering automatically to remedy or call the issue to a user's attention.
A smart rail for a window covering that uses a level sensor to indicate when the window covering is not mounted properly or has settled over time.
A smart rail for a window covering that uses glass break sensors for security applications as windows are common entry points for thieves.
A smart rail for a window covering that uses gas, smoke and air quality are also helpful indicators of other emergencies.
A smart rail for a window covering that uses IR to support external IR remote control features without a need for wireless pairing.
A smart rail for a window covering that can communicate feedback to an end user using lights, sound or voice feedback.

### III. Example Cut-In-Place Window Shade System

As noted in the Background Section above, window shades are an effective way to provide privacy, block out light and heat or insulate from heat loss. Despite there being some standard sizes for windows, the windows boxes, window moldings and window openings that windows sit inside have a lot of variation in size and dimension. Therefore, the fabric to cover a window often requires a custom width to perform the job of adequately blocking the light or looking proper aesthetically—especially for blackout shades. Custom shade rods and fabric widths are either trimmed in factory, in-store at large cutting machines or at home with hacksaws and scissors which is prone to errors and/or injury. Embodiments of a cut-in-place window shade system are described herein that provide a safe method for cutting fabric in-place on an adjustable shade roller.

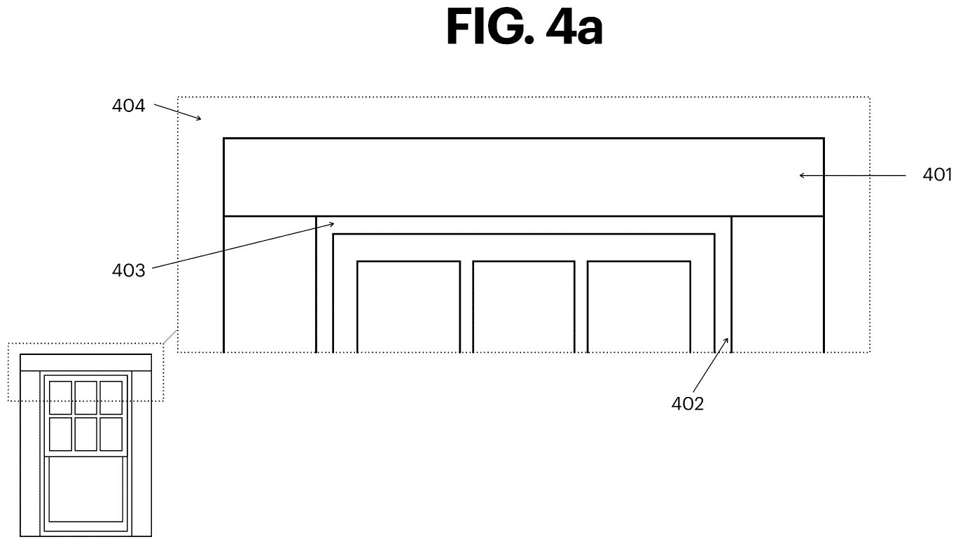

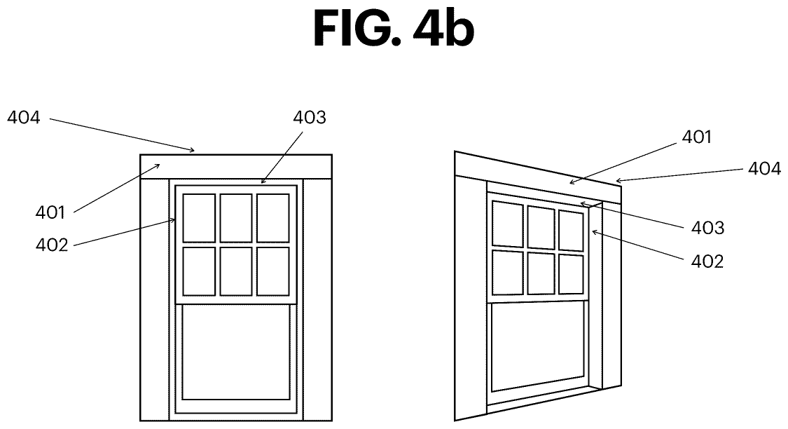

FIG. 4a depicts an interior window frame comprising a head casing 401 and a side jamb extension 402.

FIG. 4b depicts an interior window frame in detail with perspective and labels of pertinent facia for mounting a window system. FIG. 4b includes head casing 401 and side jamb extension 402 of FIG. 1a and shows head jamb extension 403 and wall 404.

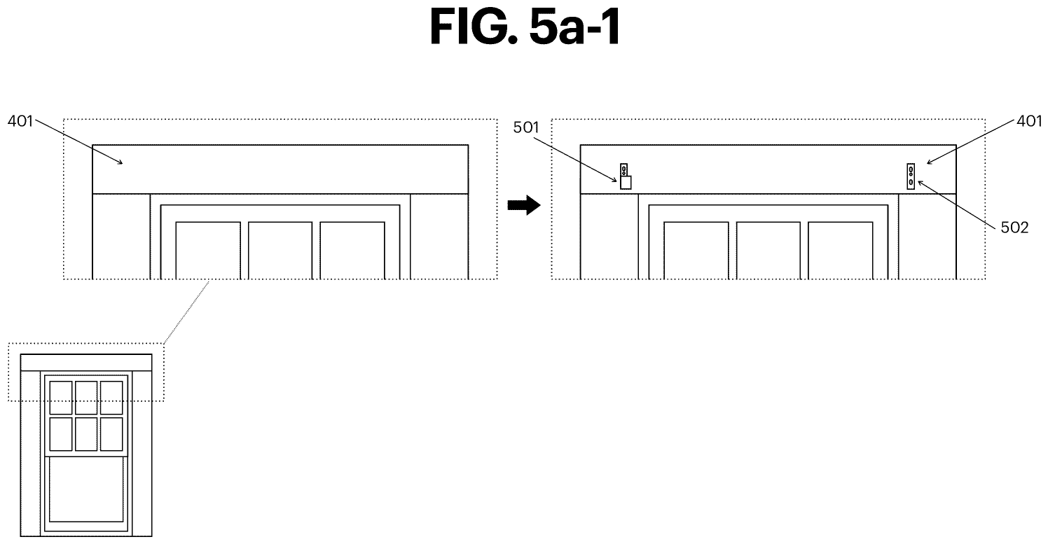

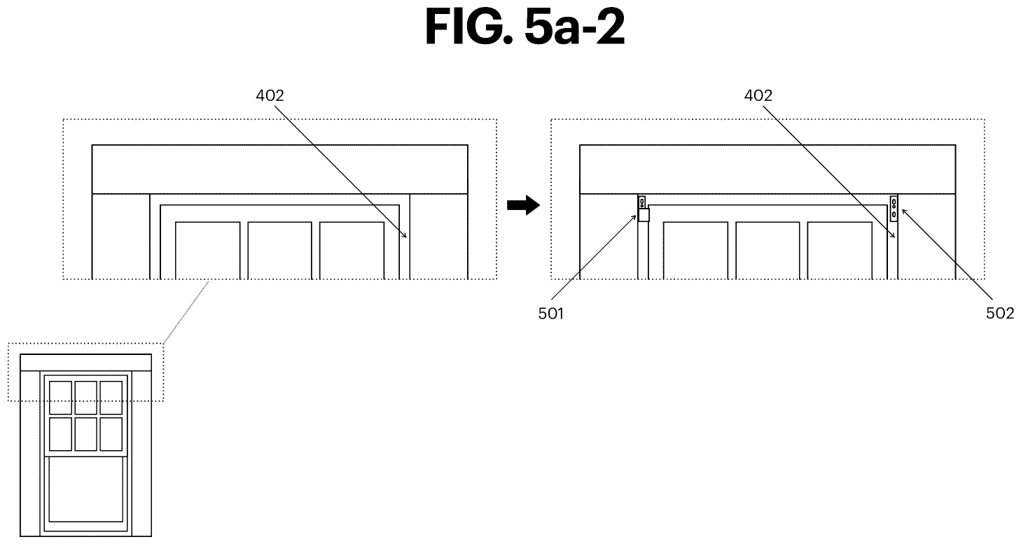

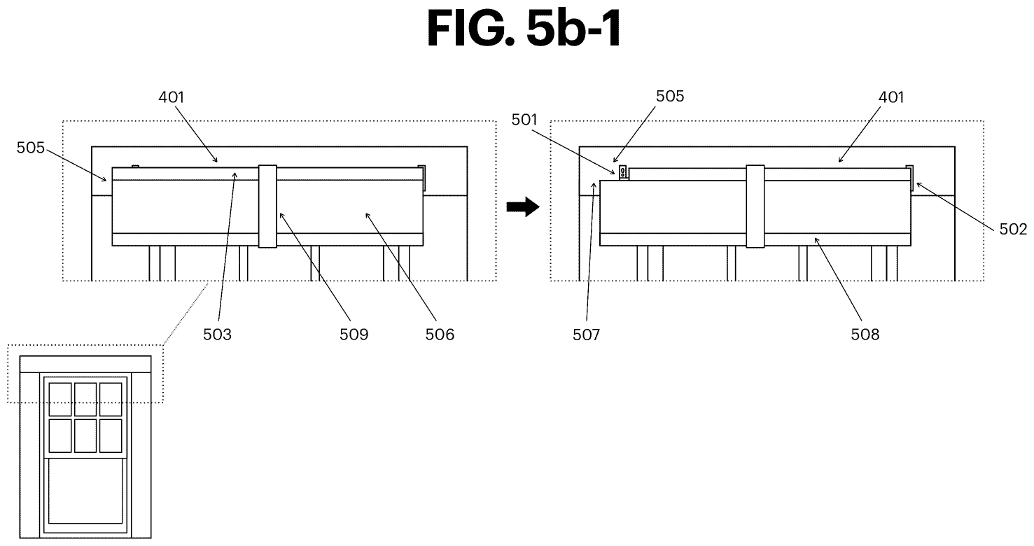

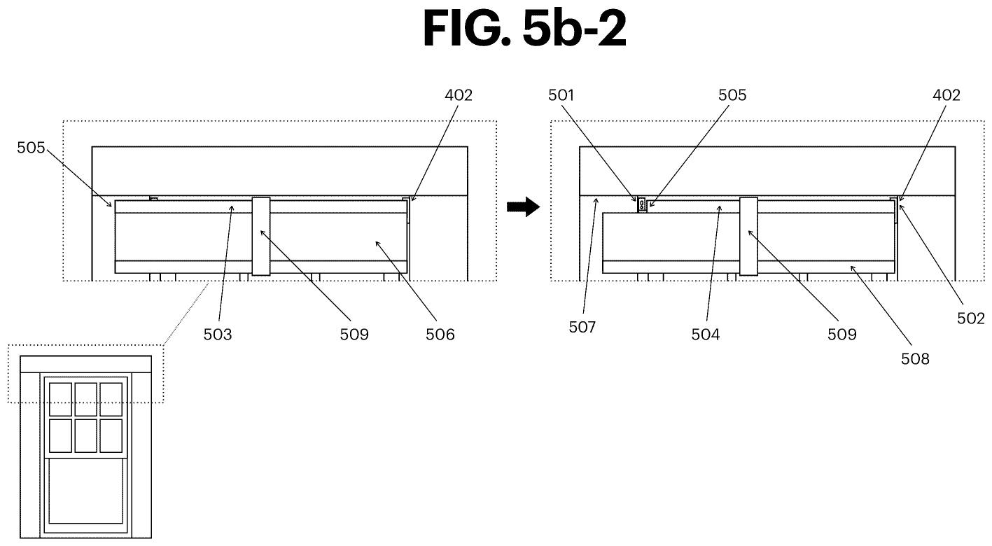

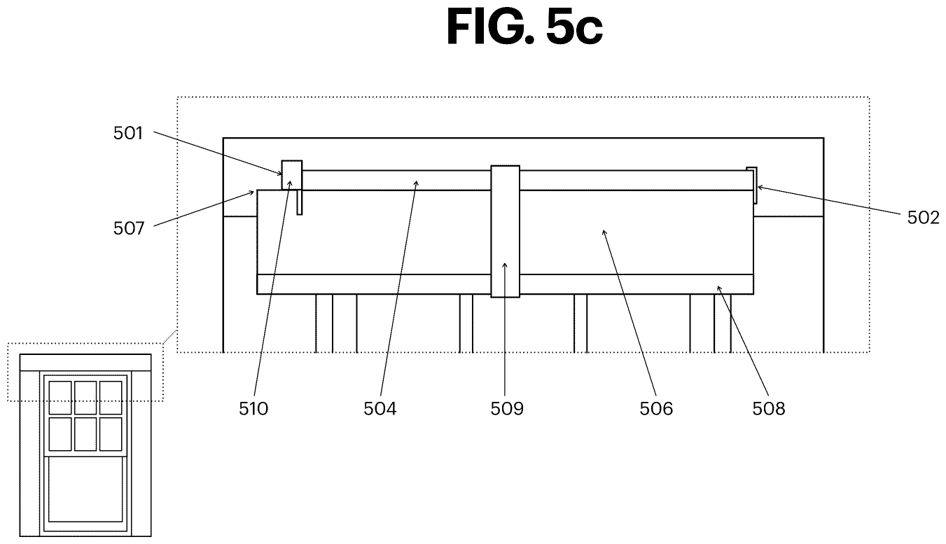

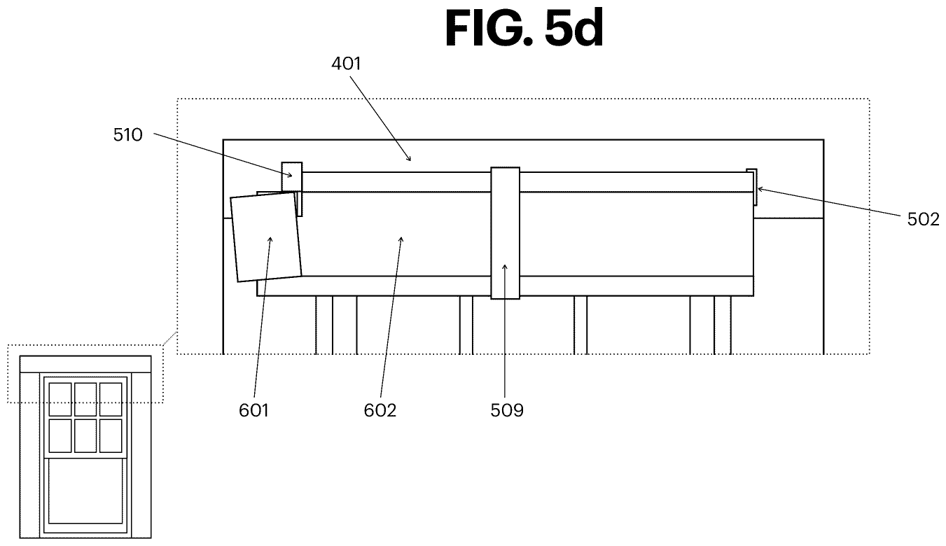

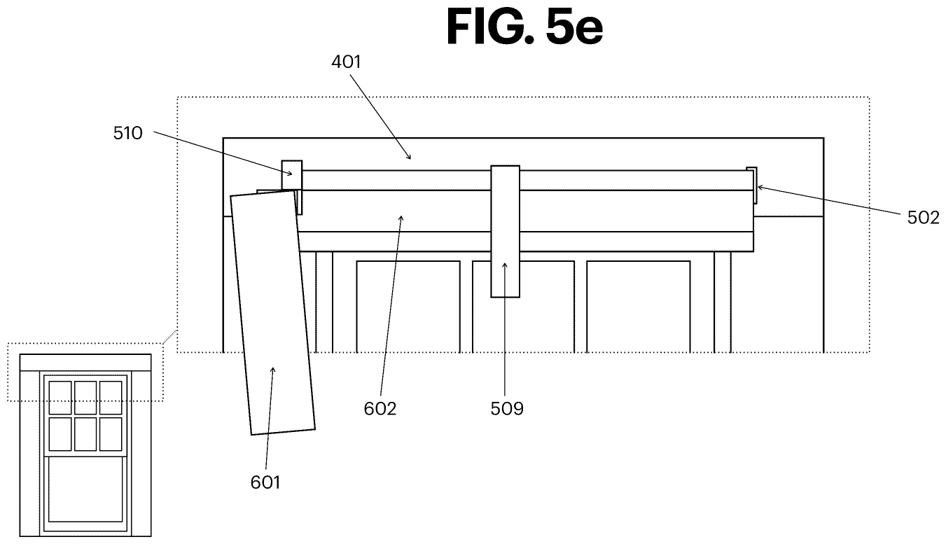

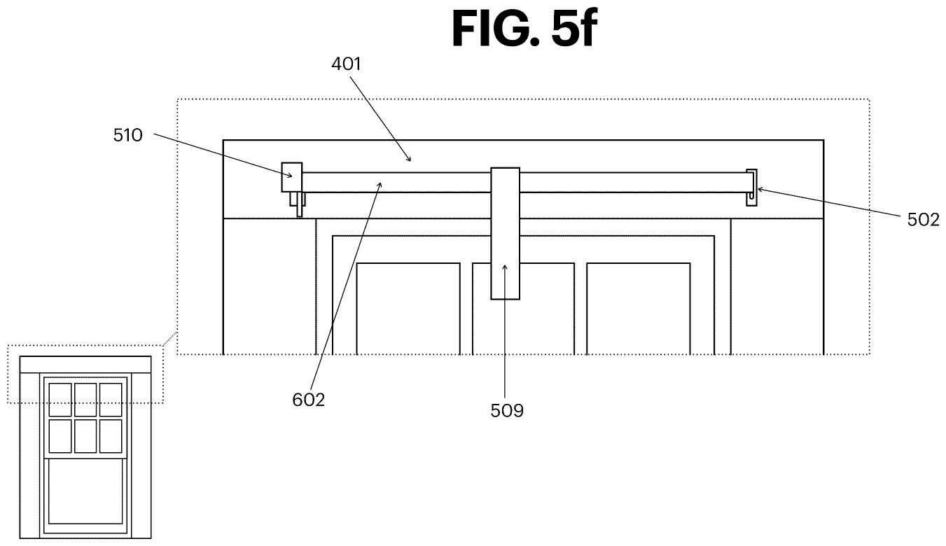

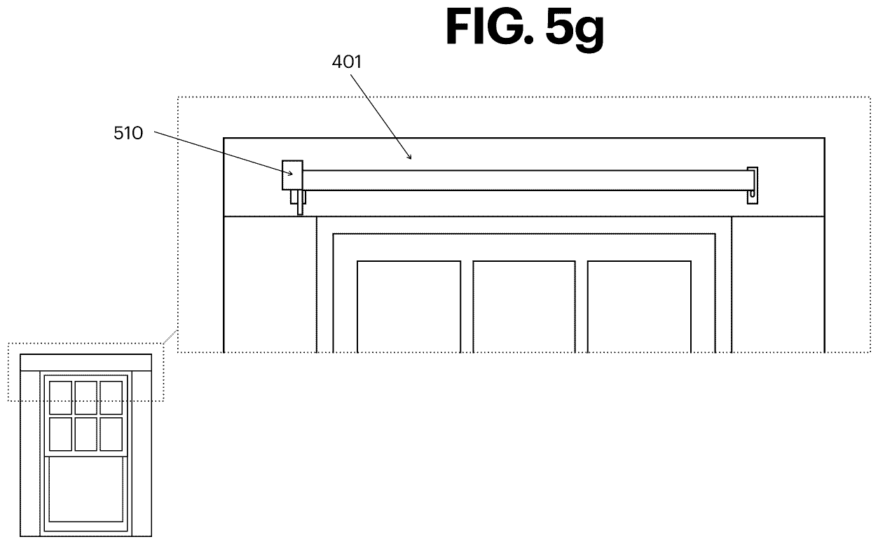

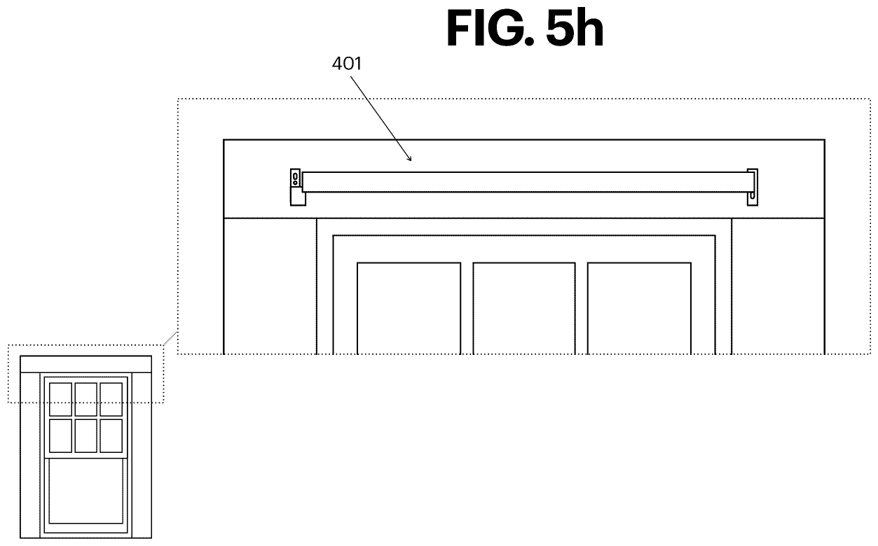

FIG. 5a-1 depicts bracket mounting locations of a cut side bracket 501 and a drive side bracket 502 for an “Outside Mount”window system.

FIG. 5a-2 depicts bracket mounting locations of cut side bracket 501 and drive side bracket 502 for an “Inside Mount”window system.

FIG. 5b-1 depicts the installation of an adjustable shade rod 503 being installed in an “Outside Mount” window system. FIG. 5b-1 also shows the following components: a locked shade rod 504 (i.e., adjustable shade rod 503 in a locked state), a rod end cap 505, fabric 506, a fabric hem/attach 507, a fabric roll 508, and a fabric belt 509.

FIG. 5b-2 depicts the installation of adjustable shade rod 503 being installed in an “Inside Mount”window system.

FIG. 5c depicts a cutter 510 being installed on adjustable shade rod 503 with fabric 506.

FIG. 5d depicts cutter 510 having begun cutting fabric 506 on the roller in place.

FIG. 5e depicts cutter 510 having almost completed cutting all fabric 506 on the roller in place. FIG. 5e further shows off cut fabric 601 and keep cut fabric 602.

FIG. 5f depicts the cut being complete.

FIG. 5g depicts after the cut is complete, fabric belt 509 is removed.

FIG. 5h depicts after the cut is complete, cutter 510 is removed.

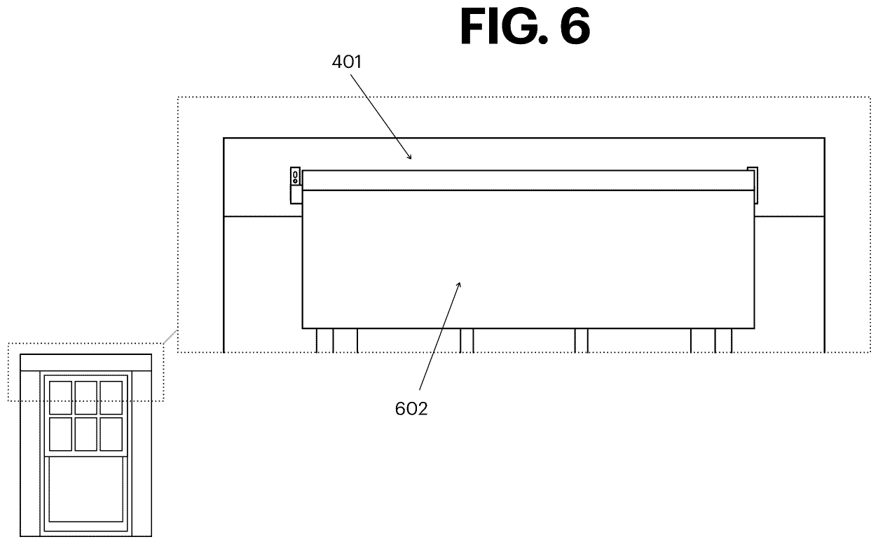

FIG. 6 depicts the cut shade being rolled down after completion of cutting.

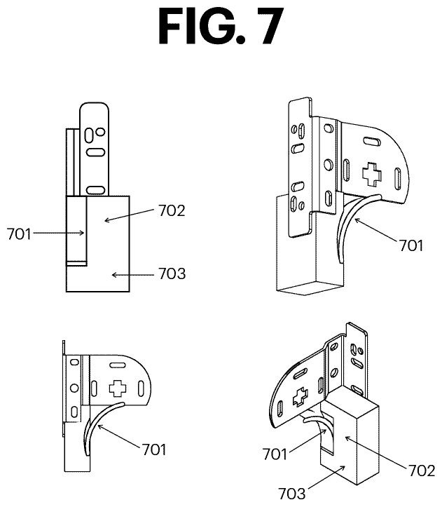

FIG. 7 depicts detailed views of the cut-side bracket 501. FIG. 7 illustrates the following components of cut-side bracket 501: off cut chute 701, feeder back plane 702 and blade back plane 703.

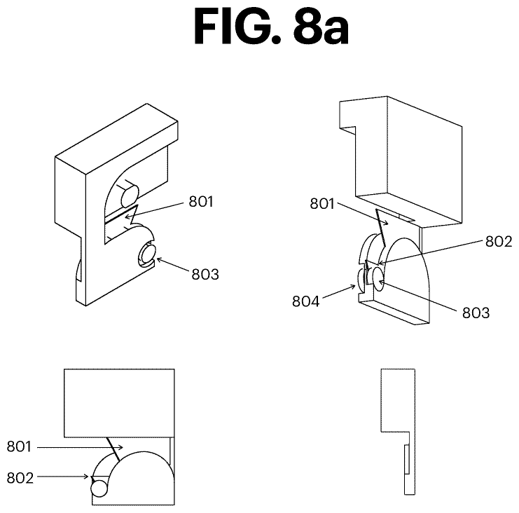

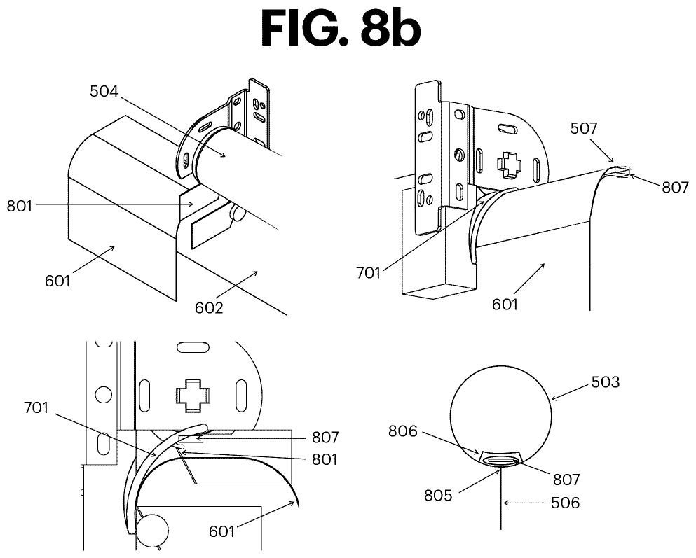

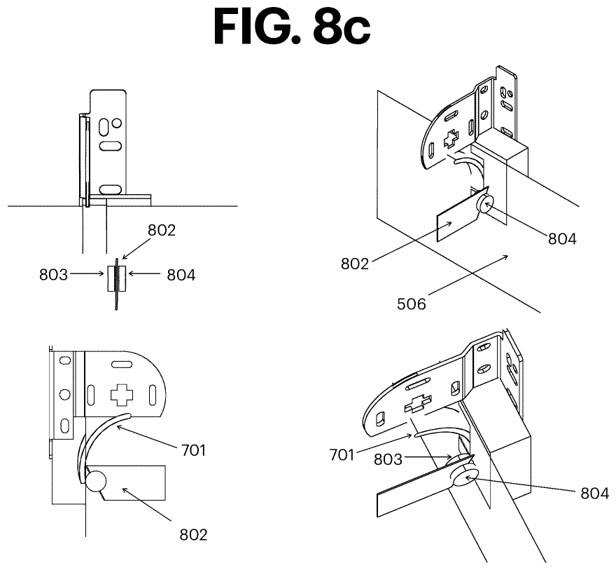

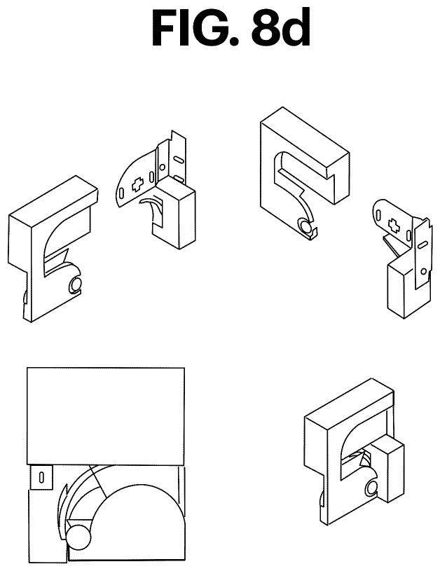

FIG. 8a depicts detailed views of cutter 510. FIG. 8a illustrates the following components of cutter 510: fabric hem/attach blade 801, fabric blade 802, off cut feeder 803 and keep cut feeder 804.

FIG. 8b depicts detailed views of cutter 510, cut-side bracket 501, rod 503 and fabric attach/hem 507 systems. FIG. 8b illustrates the following additional components: hem/attach 805, fabric attach rod-extrusion interface 806 and attach material 807.

FIG. 8c depicts detailed views of cutter 810, cut-side bracket 501, and fabric 506 systems.

FIG. 8d depicts cutter 806 and cut-side bracket 801 together.

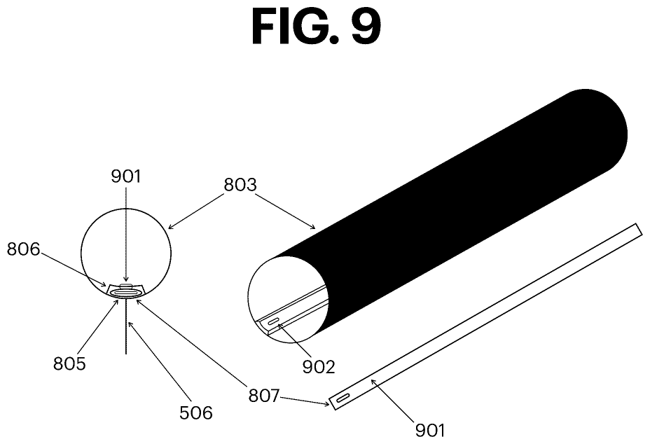

FIG. 9 depicts an attach rod interface feature 901 and an attach rod negative feature 902.

Prior to installation, adjustable rod 803 and fabric 806 are assembled by sliding fabric hem/attach 807 through fabric attach rod-extrusion interface 806. When fully inserted, attach rod interface feature 901 on fabric hem/attach 807 will click into attach rod negative feature 902 to secure adjustable rod 803 and fabric 806. The excess rolled length of fabric is held in fabric roll 508 by fabric belt 509 so that the fabric does not get bunched up or damaged during installation.

The first step of installation is choosing the best place to mount the roller shade. Installers will select either “Outside Mount” which is commonly above the window glass or “Inside Mount” which is inside the window jamb and less obtrusive. The installer will then mount both brackets including cut side bracket 501 and drive side bracket 502. Following this step, the installer will compress adjustable rod 503 and lock it. Excess width fabric will be sticking out on the side that matches cut side bracket 501. In extreme cases of window jamb interference or in cases where the fabric is interfering with an adjacent wall, a rough cut may be required. The purpose of the rough cut is to remove interfering fabric prior to cut-in-place which will cleanly cut the desired shade width. This can be achieved with shears, scissors, or other fabric cutting mechanism.

After installing and locking adjustable rod 503, cutter 510 is installed. Cutter 510 performs the important action of cutting fabric attach/hem 507 away from adjustable rod 503 and making the initial cut of fabric between the rod and the fabric blade 802. Fabric blade 802 needs to be a set distance away from the rod because fabric will be rolling up on the rod while it is being cut. The user can either use manual or motor drive to roll up the shade. While the shade is rolling up, the fabric will pass through the feeder which is composed of feeder back plane 702, off cut feeder 803 and keep cut feeder 804. The purpose of the feeder components is to prevent the fabric from bunching and maintaining constant smooth pressure before the fabric passes between fabric blade 802 and blade back plane 703. Once the fabric is cut with fabric blade 802, it is fed to off cut chute 701 to direct off cut fabric 601 away from the roller and cutting system. Meanwhile, keep cut 702 is cleanly spooled to the rod roller.

When cutting is complete, fabric belt 509 and cutter 510 can be removed and the shade is ready to use.

As shown in FIG. 4a and FIG. 4b, head casing 401, side jamb extension 402, head jamb extension 403 and wall 404 are all suitable locations for mounting a window shade system. Head casing 401 and wall 404 are often referred to as “Outside Mount” configurations while side jamb extension 402 and head jamb extension 403 are “Inside Mount”configurations.

As shown in FIG. 5a-1, a typical “Outside Mount” configuration for cut side bracket 501 and drive side bracket 502 is on head casing 401, while wall 404 above the window is also suitable.

As shown in FIG. 5a-2, a typical “Inside Mount” configuration is on side jamb extension 402.

As illustrated in FIG. 5b-1 and FIG. 2b-2, adjustable rod 503 is installed between cut side bracket 501 and drive side bracket 502. Once adjustable rod 503 is installed and locked, the rod is no longer adjustable and is now locked rod 504. Note that in an embodiment, adjustable rod 503 provides an indication in inches/millimeters the exact length of the rod when locked. Rod end cap 505 on either end of rod manages the interface between the rod and cut side bracket 501 and drive side bracket 502. Shade fabric 506 excess length is rolled up in fabric roll 508 and held in place by fabric belt 509 to improve the management of a large piece of fabric while being cut and reduce clutter.

As illustrated in FIG. 5c, cutter 510 is now engaged with cut side bracket 501. This action facilitates the cutting of fabric hem/attach 507. A closeup view of this is shown in FIG. 4 wherein fabric hem/attach blade 801 is cutting fabric hem/attach 507. Fabric hem/attach 507 is comprised of attach material 807 which is bonded via hem/attach 805 which may be adhesive or sewn. Fabric hem/attach 507 attaches to locked rod 504 via fabric attach rod-extrusion interface 806. Following this cut, further cutting will be made by the same or another blade such that the fabric is at a fixed distance away from the roller such that as the roller accumulates material and diameter of roller changes, the fabric can stay at a constant distance.

As illustrated in FIG. 5d, the fabric cutting has started and off-cut 601 is being separated from keep cut 602. Locked rod 504 is being rotated using either a manual or motorized drive system on drive side bracket 502. Fabric belt 509 is holding fabric roll 508 in place while the fabric is spooling on to locked rod 504. A closeup view is shown in FIG. 5c showing fabric blade 802 cutting the fabric while off cut feeder 803 directs the off cut to off cut chute 701. Meanwhile keep cut feeder 804 spools fabric to locked rod 504. Feeder back plane 702 and blade back plane 703 both keep the fabric moving smoothly to the blade and then to either off cut chute 701 or locked rod 504. Off cut chute 701 is critical to prevent the discarded fabric from getting snagged or caught up in the roller mechanism. Feeder back plane 702 may or may not use wheels and/or a spring-based system to keep fabric moving smoothly. Further fabric hem/attach blade 801 and/or fabric blade 802 may also use a spring to keep tension steady while cutting. Off cut feeder 803 and keep cut feeder 804 maintain consistent tension on fabric 506 as it rolls.

As illustrated in FIG. 5e, keep cut 602 is almost completed cutting. FIG. 5f shows the cut having been complete and FIG. 5g shows removal of fabric belt 509 as it is no longer needed. FIG. 5h shows the cut having been complete and FIG. 5g shows removal of cutter 510 as it is also no longer needed.

As illustrated in FIG. 6, the shade is now perfectly cut in place and can be rolled down and used.

As illustrated in FIG. 9, an attach rod interface feature 901 allows fabric hem/attach 807 to click into the rod at the attach rod negative feature 902 and lock so that cutting is performed while fabric hem/attach 807 is locked firmly into locked rod 504. In an embodiment, the material of attach rod interface feature 901 is soft and can be deformed easily but locks inside attach rod negative feature 902 on the inside of an aluminum extrusion. A user can use their finger to depress attach rod interface feature 901 and release fabric hem/attach 807 from being locked inside locked rod 504.

### IV. Additional Embodiments

In certain embodiments, adjustable rod 503 may comprise any of a variety of integrated analog and/or digital sensors such as level, light, temperature, humidity, glass break, occupancy, and/or vibration/accelerometer. Sensors such as level can assist during the installation of shade and cutting to ensure proper cutting. Vibration/accelerometer can assist in determining error modes, such when the shade has hit something, or control modes, such as when a user pulls on the shade to indicate they want the shade down. Light and heat sensors can indicate proper times to roll up/down shade. Occupancy and glass break can assist with security and other matters.

The above-described cut-place-system can be extended to any custom fabric system such as screen doors, window screens, window awnings or video projection screens.

The above-described systems can be extended to any custom fabric system such as screen doors, window screens, window awnings or video projection screens.

In view of the foregoing description, it can be seen that the systems and methods described herein encompass at least the following:
A cut-in-place window shade system in accordance with any of the embodiments described herein.
A method of cutting a window shade in place in accordance with any of the embodiments described herein.
A cut-in-place system for any of a window shade, a screen door, a window screen, a window awning, or a video projection screen in accordance with any of the embodiments described herein.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A rail of a window covering, comprising:
a microcontroller communicatively coupled to a motor configured to raise and lower the rail;
a rail battery; and
at least one sensor that generates a sensor signal;
the microcontroller configured to:
detect that the rail is docked;
determine a state of charge of a motor battery;
determine a state of charge of a rail battery in the rail;
in response to the state of charge of the motor battery having a value below a first predetermined threshold and the state of charge of the rail battery having a value above a second predetermined threshold, charge the motor battery with energy stored in the rail battery; and
in response to the state of charge of the rail battery decreasing below a third predetermined threshold, terminate the charging of the motor battery.

2. The rail of claim 1, wherein the microcontroller is further configured to:
in response to the state of charge of the motor battery rising above a fourth predetermined threshold, terminate the charging of the motor battery.

3. The rail of claim 1, wherein the microcontroller is further configured to:
receive at least one of a control signal or a sensor signal;
in response to the received at least one of a control signal or a sensor signal, control the motor to lower the rail; and
detect the rail is undocked.

4. The rail of claim 1, wherein the motor is physically separate from the rail.

5. The rail of claim 1, wherein the motor is included in the rail.

6. The rail of claim 1, further comprising:
an integrated solar panel configured to convert received light to energy that is stored in the rail battery.

7. The rail of claim 1, wherein the at least one sensor includes at least one of:
an occupancy sensor,
a heat sensor,
a light sensor,
a proximity sensor,
an air quality sensor,
a smoke sensor,
a gas sensor,
a level sensor,
a pressure sensor,
an accelerometer,
a compass,
a glass break sensor, or
an infrared sensor.

8. The rail of claim 1, wherein the microcontroller is further configured to at least one of:
control the window covering based on at least one of zip code or time of day; or
communicate feedback to an end user using at least one of lights, sound, or voice feedback.

9. The rail of claim 1, wherein the at least one sensor determines at least one of:
the window covering stopping when hitting a windowsill;
a quality of seal of the window covering;
water condensation;
the window covering is not mounted properly or has settled over time; or
an error case.

10. A method in a microcontroller in a rail of a window covering, comprising:
detecting that the rail is docked;
determining a state of charge of a motor battery;
determining a state of charge of a rail battery in the rail;
in response to the state of charge of the motor battery having a value below a first predetermined threshold and the state of charge of the rail battery having a value above a second predetermined threshold, charging the motor battery with energy stored in the rail battery; and
in response to the state of charge of the rail battery decreasing below a third predetermined threshold, terminating said charging the motor battery.

11. The method of claim 10, further comprising:
in response to the state of charge of the motor battery rising above a fourth predetermined threshold, terminating said charging the motor battery.

12. The method of claim 10, further comprising:
receiving at least one of a control signal or a sensor signal;
in response to the received at least one of a control signal or a sensor signal, controlling a motor to lower the rail; and
detecting the rail is undocked.

13. The method of claim 10, wherein the rail battery is coupled to a solar panel configured to convert received light to energy and store the energy in the rail battery.

14. The method of claim 10, wherein the solar panel is located in the rail.

15. The method of claim 10, wherein the solar panel is separate from the rail.

16. The method of claim 10, wherein the at least one sensor includes at least one of:
an occupancy sensor,
a heat sensor,
a light sensor,
a proximity sensor,
an air quality sensor,
a smoke sensor,
a gas sensor,
a level sensor,
a pressure sensor,
an accelerometer,
a compass,
a glass break sensor, or
an infrared sensor.

17. The method of claim 10, further comprising at least one of:
controlling the window covering based on at least one of zip code or time of day; or
communicating feedback to an end user using at least one of lights, sound, or voice feedback.

18. The method of claim 10, further comprising:
determining by the at least one sensor at least one of:
the window covering stopping when hitting a windowsill;
a quality of seal of the window covering;
water condensation;
the window covering is not mounted properly or has settled over time; or
an error case.

19. A cut-in-place window shade system, comprising:
a cut side bracket mounted to a wall;
a drive side bracket mounted to the wall;
adjustable shade roller configured to hold a fabric roll, the adjustable shade roller installed between the cut side bracket and the drive side bracket to become a locked rod, an excess width of the fabric roll extending outside the cut side bracket; and
a cutter removably attached to the cut side bracket, a blade of the cutter configured to cut an off cut of fabric from the fabric roll rotated on the locked roller.

20. The cut-in-place window shade system of claim 19, further comprising:
a motorized drive system connected to the drive side bracket that is configured to rotate the fabric roll on the locked rod.
